(19) United States
(12) Patent Application Publication
(10) Pub. No.: US 2024/0215598 A1
(43) Pub. Date: Jul. 4, 2024

(54) PLANT-BASED CHEESE PRODUCT AND METHOD OF MAKING A PLANT-BASED CHEESE PRODUCT

(71) Applicant: Kraft Foods Group Brands LLC, Chicago, IL (US)

(72) Inventors: Tracy Joella Sanborn, Glen Ellyn, IL (US); Mary C. Doyle, Chicago, IL (US); Lacey Ann Thomas, Frankfort, IL (US); Alexis Marie Fye, Hawthorn Woods, IL (US); Samy Darwan, Chicago, IL (US); Andrew Edward McPherson, Mt. Prospect, IL (US)

(21) Appl. No.: 18/563,086

(22) PCT Filed: Apr. 29, 2022
(86) PCT No.: PCT/US2022/027051

§ 371 Date: Nov. 21, 2023

Related U.S. Application Data
(60) Provisional application No. 63/191,795, filed on May 21, 2021.

(51) Int. Cl. A23C 20/02

(52) U.S. Cl. CPC A23C 20/025

(57) ABSTRACT

A plant-based cheese product is provided. The plant-based cheese products have an appearance, cold texture, and melting characteristics similar to a dairy-based cheese. The cheese products include a plant-based protein, at least a first starch and a second starch, a fat component, and an acidulant. The first starch comprises a hydrophobic starch. The second starch comprises a modified starch. The fat component has a solid fat content in the range of 30% to about 60% at 50° F. and 0% to about 10% at 92° F. A flexibility enhancing agent may also be included.

### FIELD

This application relates generally to plant-based cheese products.

### BACKGROUND

Some commercially available plant-based cheese products have been able to replicate the color and texture of dairy-based cheese products at refrigerated temperatures. However, these typical plant-based cheese products often do not have other functional characteristics expected of dairy-based cheeses, including melting characteristics at cooking temperatures. Indeed, some plant-based cheese products do not melt uniformly at high temperatures, such as when making foods like a grilled cheese or pizza. For example, currently available plant-based cheese products in shredded form often retain their shredded appearance even after being exposed to cooking temperatures. These plant-based cheese products are not as well accepted by consumers who expect a cooking and eating experience that replicates dairy-based cheeses.

### BRIEF DESCRIPTION OF THE DRAWINGS

FIG. 1 is a black and white reproduction of an originally colored photograph of a grilled cheese type product with an example plant-based cheese product melted therein; and

FIG. 2 is a black and white reproduction of an originally colored photograph of another grilled cheese type product with another example plant-based cheese product melted therein.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Described herein are plant-based cheese products. For purposes herein, the term “plant-based cheese product” refers to cheese analogues or cheese alternatives prepared with proteins of non-dairy origin. The plant-based cheese products have an appearance, cold texture, and melting characteristics similar to a dairy-based cheese. The dairy proteins in dairy-based cheese create a network and structure that results in the cold texture and hot/melt texture of the dairy-based cheese. As the plant-based cheese product disclosed herein may be free of dairy proteins, dairy proteins cannot be relied upon to produce the desired cold texture and melting characteristics, including meltability at conventional cooking temperatures and texture upon melting. Rather, it has been unexpectedly found that a plant-based cheese product with characteristics consistent with consumer expectations for a dairy-based cheese could be obtained through use of a combination of a plant-based protein, fat component, hydrophobic starch, and a modified starch. In some embodiments, a plant-based cheese product with characteristics consistent with consumer expectations for a dairy-based cheese could be obtained through use of a combination of a plant-based protein, fat component, hydrophobic starch, a modified starch, and a flexibility enhancing agent.

In one approach, the plant-based cheese product includes: a plant-based protein; at least a first and second starch, the first starch comprising a hydrophobic starch and the second starch comprising a modified starch; a flexibility enhancing agent; a fat component having a solid fat content in the range of 30% to about 60% at 50° F. and about 0% to about 10% at 92° F.; and an acidulant in an amount effective to provide a pH of the plant-based cheese product of about 4.5 to about 5.7.

The plant-based cheese product disclosed herein may formed into desirable shape. In some examples, the plant-based cheese product is in the form of a cheese block, a sliced cheese, a diced cheese, or a shredded cheese. In some approaches, the plant-based cheese product may be in the form of an oil-in-water emulsion.

The plant-based cheese product includes a plant-based protein. For sake of simplicity and purposes herein, the term “plant-based protein” includes any non-dairy and non-animal-based proteins. The term “plant-based protein” also specifically encompasses fungus-based proteins or proteins produced via fermentation by microbes, even though those proteins are not of plant origin.

Any suitable plant-based protein may be used in the plant-based cheese product. In some embodiments, the plant-based protein comprises one or more of chickpea protein, fava protein, soy protein, mung bean protein, pea protein, canola protein, and lentil protein. In some approaches, the plant-based protein can be in the form of an isolate, a concentrate, or a flour, though the precise form of the plant-based protein is not believed to be particularly limited. In one embodiment, the plant-based protein comprises chickpea protein. In some examples, the fungus protein comprises mycoprotein.

As noted above, the plant-based protein may also be of microbial origin. For example, proteins commonly of dairy-based origin, such as casein or whey, may be obtained via microbial fermentation. If produced by a microorganism using a non-dairy based substrate and fermentation medium, the resulting protein would be considered a plant-based protein for purposes herein.

In some embodiments, the plant-based protein is the only source of protein in the plant-based cheese product. In this respect, in some embodiments, the plant-based cheese product includes no animal proteins, including, for example, casein and whey. Additionally, or alternatively, the product may be a vegan cheese product (i.e., there are no ingredients of animal origin of any kind in the cheese product).

In one approach, the plant-based protein is present in an amount within the range of about 1 wt % to about 25 wt % crude protein, based on a total weight of the plant-based cheese product. In another approach, the plant-based protein is present in an amount within the range of about 2 wt % to about 20 wt %, about 2 wt % to about 15 wt %, about 4 wt % to about 15 wt %, or about 4 wt % to about 10 wt % crude protein based on a total weight of the plant-based cheese product. The amount of crude protein in a plant-based protein ingredient may depend on the form of the ingredient (e.g., whether the ingredient is in the form of an isolate, a concentrate, or a flour). Therefore, for purposes herein, plant-based protein refers to the crude protein content, i.e., the amount of protein contributed by the ingredient that delivers the plant-based protein. For instance, the commercially available ARTESA® chickpea protein product includes about 60% protein and 40% non-protein components. If a plant-based cheese product includes about 13 wt % ARTESA® chickpea protein product, the plant-based cheese product will include about 8 wt % plant-based protein, for percentage purposes herein.

In some approaches, it has been found to be advantageous that the plant-based protein have a small mean particle size to allow for good dispersion of the protein within the fat component. For example, use of a plant-based protein having a mean particle size below about 15 microns may be beneficial. In another aspect, use of a plant-based protein having a mean particle size in the range of about 6 to about 15 microns, in another aspect about 8 to about 11 microns, may be beneficial. In some examples, the mean particle size of the protein may be determined using dynamic light scattering. As an example, a Zetasizer Ultra-DLS (Malvern) may be used to measure the mean particle size using dynamic light scattering.

In some approaches, the inclusion of chickpea protein, and with the small mean particle size described herein, has surprisingly been found to provide significant benefits to the “oiling off” problem that can occur with dairy-based cheese products when not stored at refrigerated temperatures. Oiling off refers to the separation of oil from the other ingredients, resulting in a product that exudes oil during production, at room temperature, or when heated.

The plant-based cheese products further include a combination of at least two starches to achieve the desired characteristics. The plant-based cheese product includes at least a first starch and a second starch. As mentioned above, the combination of the first starch and the second starch can provide the plant-based cheese product the desired cold texture and hot/melt texture.

In one aspect, the first starch is a hydrophobic starch. The hydrophobic starch may act as an emulsifier during the manufacturing process and in the plant-based cheese product.

The hydrophobic starch may also provide water management to the plant-based cheese product.

Any suitable hydrophobic starch may be used. In some examples, the hydrophobic starch may be an octenyl succinic anhydride (OSA) starch. Examples of suitable hydrophobic starches include, for example, ACCUBIND® starch (Cargill) or STA-MIST® starch (Tate & Lyle), which are both OSA-modified dent corn starches. It is presently believed that the hydrophobic starch acts as an emulsifier. In some examples, the fat droplet size distribution may be measured by a Bruker time-domain nuclear magnetic resonance (TD-NMR).

In one approach, the first starch is present in an amount within the range of about 0.5 wt % to about 15 wt %, in another aspect about 1 wt % to about 13 wt %, and in another aspect about 5 wt % to about 15 wt %, based on a total weight of the plant-based cheese product.

The second starch is a modified starch different from the first starch. In one approach, any suitable modified waxy starch may be used. In some examples, the modified waxy starch may be a waxy (non-amylose containing starch) starch that is crosslinked, substituted, or both crosslinked and substituted. The modified waxy starch is selected to provide viscosity and water management when the cheese product is at elevated temperature, either during the manufacturing process or upon heating by the consumer. For instance, the modified starch may be REZISTA® starch (Tate & Lyle) and/or SHUR-FIL® 677 modified starch (Tate & Lyle). The SHUR-FIL® 677 modified starch can provide thickening effect at elevated temperatures, such as between 100 to 150° F. In some examples, the modified starch may be a dent corn starch that forms a thermoreversible gel.

In another approach, the second starch may also be selected from hydrolyzed, amylose-containing starches. In one exemplary approach, the starch may be an acid-thinned starch. For instance, the acid-thinned starch may be THINGUM® starch (Tate & Lyle). The hydrolyzed, amylose-containing starch is selected to provide firmness upon cooling, a low hot viscosity, and sliceability to the plant-based cheese product.

At least in some embodiments, it has been found advantageous that a combination of modified starches be included (i.e., both a modified waxy starch and a hydrolyzed, amylose-containing starch) along with the first hydrophobic starch. The relative amounts of the modified starches are selected to provide the desired properties in the cheese product. The combination of second starches can provide desirable physical properties at both hot and cold temperatures (such as firmness upon cooling and desirable viscosity at elevated temperatures), thereby better replicating the properties of dairy-based cheeses and meeting consumer expectations.

In one approach, the second starch is present in an amount within the range of about 0.5 to about 10 wt %, in another aspect about 1 wt % to about 5 wt %, based on a total weight of the plant-based cheese product. The ranges here are applicable to modified waxy starch and hydrolyzed amylose-containing starch included individually, or to a combination of modified waxy starch and hydrolyzed amylose-containing starch.

In one approach, the modified waxy starch and hydrolyzed amylose-containing starches may be included in a ratio of about 10:1 to about 1:10, and in another aspect about 5:1 to about 1:5, and in another aspect about 3:1 to about 1:3.

Water is also included in an amount of about 30 wt % to about 60 wt %, in another aspect about 37 wt % to about 55 wt %, in another aspect about 42 wt % to about 55 wt %, based on a total weight of the plant-based cheese product.

The plant-based cheese product may further include a flexibility enhancing agent, which results in decreased friability and/or rigidity of the cheese product. For example, the flexibility enhancing agent may act as a filler. Additionally, or alternatively, the flexibility enhancing agent may contribute to flexibility of the plant-based cheese product. The flexibility enhancing agent may be a polysaccharide, gum, or hydrocolloid. Suitable flexibility enhancing agents include, for example, one or more of instant starch, xanthan gum, guar gum, locust bean gum, cellulose gum, fenugreek gum, konjac gum, agar, gellan gum, propylene glycol alginate (PGA), alginate, microcrystalline cellulose (MCC), carboxymethyl cellulose (CMC), konjac glucomannan, carrageenan, and pectin. In some examples, the flexibility enhancing agent comprises one or more of carrageenan and pectin.

In general, the cold and hot melt characteristics and texture of the plant-based cheese product can be manipulated by adjusting the relative amounts of the hydrophobic and modified starches, as well as the amounts of total starch relative to the protein content of the plant-based cheese product. Further, additional starches may be included, if desired. Generally, as the amount of protein in the plant-based cheese is decreased, additional starch is needed to provide the desired texture and functionality.

In one approach, the flexibility enhancing agent is present in an amount within the range of about 0.1 wt % to about 20 wt %, based on a total weight of the plant-based cheese product. In another approach, the flexibility enhancing agent is present in an amount within the range of about 0.1 to about 15 wt %, about 0.1 to about 12 wt %, about 0.2 to about 12 wt %, about 1 wt % to about 15 wt %, about 1 wt % to about 12 wt %, about 2 wt % to about 10 wt %, about 2 wt % to about 5 wt %, or about 5 wt % to about 10 wt %, based on a total weight of the plant-based cheese product.

In some embodiments, the combination of starches (and optionally flexibility enhancing agent) are present in an amount effective to achieve a complex viscosity of the plant-based cheese product at a frequency of 10 rad/s and a temperature of 80° C. within the range of about 20 Pa·s to about 200 Pa·s. In some embodiments, the combination of starches (and optionally the flexibility enhancing agent) are present in an amount effective to achieve a complex viscosity of the plant-based cheese product at 10 rad/s and 80° C. within the range of about 20 Pa·s to about 180 Pa·s, the range of about 20 Pas to about 150 Pa·s, the range of about 20 Pa· s to about 120 Pa·s, the range of about 20 Pa·s to about 100 Pa·s, the range of about 20 Pa·s to about 80 Pa·s, the range of about 20 Pa·s to about 50 Pa·s, the range of about 50 Pa·s to about 200 Pa·s, the range of about 80 Pa·s to about 200 Pa·s, the range of about 100 Pa·s to about 200 Pa·s, the range of about 120 Pa·s to about 200 Pa·s, the range of about 150 Pa·s to about 200 Pa·s, the range of about 180 Pa·s to about 200 Pa·s, the range of about 50 Pa·s to about 180 Pas, the range of about 80 Pa·s to about 180 Pa·s, or the range of about 100 Pa·s to about 150 Pa·s. As explained in more detail below, because some products may be shear thinning, the complex viscosity may be lower than the zero shear viscosity.

In any of these embodiments the complex viscosity may be measured after heating a mixture (or second mixture) or combination of the ingredients of the plant-based cheese product to a temperature of about 80° C. Additionally, or alternatively, the complex viscosity may be measured before the heated mixture or combination is cooled to form the plant-based cheese product.

As used herein, complex viscosity is the viscosity estimated from a dynamic rheological experiment. It is the flow property of the material as a response to applied sinusoidal to stress/strain. In some approaches, addition of a flexibility enhancing agent may cause shear thinning. Firmness of the product is proportional to the molar concentrations of intermolecular bonds. It is represented by the shear modulus G that is given by G=nRT where “n” represents the molar concentration of the bonds. The firmness is calculated by G′, G′ values by taking into account the viscoelastic behavior of the material. Since for all these materials G′>>G″, G (shear modulus or firmness) will be approximately the same as G′. Relaxation time is the measure of how fast material relaxes to an equilibrium state after releasing the applied stress/strain. For example, viscous liquid relaxes faster by dissipating the energy through flow and will have 0 relaxation time. Elastic solids take longer time to reach an equilibrium state by stretching themselves back. Hence, materials with lower relaxation time will stick to a surface on application of a uniform strain. Relaxation time is inversely proportional to tan delta. At any temperature, more stability or resistance to change in viscoelastic properties can be expected for the materials with higher relaxation time or low tan delta values. Tan delta is the ratio of energy dissipated to the energy stores in a viscoelastic material, when the material is subjected to stress or strain. Apparent zero shear viscosity is the product of firmness (shear modulus) and relaxation time. It is the material property related to internal structure of the material and independent of applied strain rate. Complex viscosity is the viscosity estimated from a dynamic rheological experiment. It is the flow property of the material as a response to applied sinusoidal to stress or strain. For this study, this was measured at a frequency of 10 rad/s. Some materials may be shear thinning; therefore, complex viscosity at 10 rad/s may be lower than the zero shear viscosity.

For example, the complex viscosity of an oil-in-water emulsion product can be measured using a DHR rheometer with parallel plate attachments (25 mm cross hatched parallel top plate with 60 mm cross hatched bottom plate and 1 mm gap between plates) over a ramping temperature range of 5-80° C. Specifically, temperature increased at 2° C./min, the applied stress was 10 Pa, and the frequency was 10 rad/s. The processing conditions greatly impact the resulting product viscosity as smaller emulsion droplets will produce significantly more viscous product, which is, accordingly, more stable to creaming forces.

The plant-based cheese product further includes a fat component having a solid fat content in the range of about 30% to about 60% at 50° F. and 0% to about 10% at 92° F. When the fat component has a solid fat content within the specified ranges, the fat component may act similarly to butter fat, which may contribute to the plant-based cheese product having a flavor profile, cold texture, and melt profile similar to a dairy-based cheese.

Any suitable fat component comprising one or more solid fats, liquid oils, or combination thereof having a solid fat content in the range of about 30% to about 60% at 50° F. and 0% to about 10% at 92° F. may be used. In some examples, the fat component comprises one or more of coconut oil, palm oil, palm oil fraction, shea butter, and shea olein. In some of these examples, the fat component further comprises one or more of soybean oil, sunflower oil, olive oil, canola oil, peanut oil, sesame oil, and corn oil to provide a blend of ingredients to provide the desired solid fat content at the respective temperatures. In other examples, the fat component comprises the coconut oil.

In one approach, the fat component is present in an amount within the range of about 15 to about 30 wt %, in another aspect about 20 wt % to about 30 wt %, based on a total weight of the plant-based cheese product.

The plant-based cheese product further includes an acidulant in an amount effective to provide a pH of the plant-based cheese product of about 4.5 to about 5.7, in another aspect about 4.8 to about 5.7, in another aspect about 4.8 to about 5.5, in another aspect about 4.8 to about 5.0, in another aspect about 5.0 to about 5.7, and in another aspect about 5.2 to about 5.5. Any suitable acidulant may be used. In one example, the acidulant comprises one or more of citric, acetic, phosphoric, sorbic, and lactic acid.

For instance, the plant-based cheese products described herein have acceptable meltability at cooking temperatures, firm texture at refrigeration temperature, and suitable overall mouthfeel similar to dairy-based cheese products. The plant-based cheese products maintain physical integrity at refrigeration temperatures but also melt when exposed to elevated temperatures.

Antimicrobial agents may also be added to the plant-based cheese products in order to enhance resistance to bacterial and mold growth, such as by addition of sorbic acid, cultured vinegar, cultured sugar, cultured dextrose. In some approaches, the antimicrobial agent may also be serving as an acidulant.

The plant-based cheese product may be provided in a variety of flavors, such as American, Swiss, gouda, provolone, cheddar, Colby, Colby-jack, pepper-jack, or mozzarella. Flavoring agents may be added to achieve the desired flavor profile. Colors may also be added to achieve the desired color to the plant-based cheese product.

In another approach, inclusions may be added to achieve the desired flavor profile. For example, herbs, spices, peppers, chilies, garlic, natural or artificial flavors, and the like, alone or in combination, may be added to provide a desired flavor profile.

In addition to the hydrophobic starch, a chemical emulsifier may be included. Suitable chemical emulsifiers include, for example as orthophosphates (including disodium phosphates, monosodium phosphates, and trisodium phosphates), sodium hexametaphosphates, sodium acid pyrophosphates, trisodium citrate, polyoxyethylene sorbitan monostearate (polysorbate 60), or other emulsifiers or combinations of emulsifiers. In other approaches, no chemical emulsifiers are included.

In some examples, the plant-based cheese product may additionally include a flavor masking agent. Masking agents may include any suitable ingredient effective to lower a perceived intensity of a particular flavor. In some applications, consumers may perceive non-dairy proteins as contributing an off-flavor to a cheese-type product (i.e., a flavor inconsistent with consumer expectations for a dairy-based cheese). For example, soy is sometimes perceived as contributing an undesirable beany flavor to food products. To reduce the flavor of certain non-dairy proteins, it may be desirable to include a flavor masking agent. For example, agents may include sweeteners (including nutritive and non-nutritive sweeteners), flavors, bitter blockers, or other suitable additive. Any suitable amount may be included. In one particular approach, the agent may be effective to bind to the off-flavors, thereby reducing or preventing the perception of the flavor. Suitable flavor binders include, for example, thaumatin and neohesperidin dihydrochalcone (NHDC), which may also be categorized as sweeteners, and generally are included in an amount within the range of greater than 0 wt % to about 0.005 wt %, based on a total weight of the plant-based cheese product.

The plant-based cheese products described herein can be made by a variety of methods. In one approach, the plant-based cheese products can be made by the method comprising combining a fat component with water, a plant-based protein, and at least two starches, wherein the first starch is a hydrophobic starch, and the second starch is a modified starch. The fat component has a solid fat content in the range of about 30% to about 60% at 50° F. and 0% to about 10% at 92° F. Other optional ingredients may be added at this point or later in the process. The ingredients are blended at a shear rate sufficient to provide a homogeneous mixture. The ingredients are also heated at a temperature of about 160° F. to about 215° F., in another aspect about 165° F. to about 200° F., and in another aspect about 175° F. to about 190° F. The ingredients may be blended while heating, if desired. Further, the ingredients may be held at the increased temperature for a time effective to pasteurize the mixture, such as with continued mixing. The mixture may be heated via steam injection or other means.

In another approach, the fat component may be melted, such as in a cooker, before the other ingredients are added, as described above.

In another approach, the plant-based cheese products can be made by the method comprising melting a fat component, adding at least two starches to the melted fat, wherein the first starch is a hydrophobic starch, and the second starch is a modified starch, and mixing the at least two starches and melted fat component to thoroughly distribute the at least two starches into the melted fat to provide a homogenous first mixture. The fat component has a solid fat content in the range of about 30% to about 60% at 50° F. and 0% to about 10% at 92° F. Additional ingredients can then be added, including water, acidulant, plant-based protein, and flexibility enhancing agent. Other optional ingredients may be added at this point or later in the process. The ingredients are blended at a shear rate sufficient to provide a homogeneous mixture. The ingredients are also heated at a temperature of about 160° F. to about 215° F., in another aspect about 165° F. to about 200° F., and in another aspect about 175° F. to about 190° F. The ingredients may be blended while heating, if desired. Further, the ingredients may be held at the increased temperature for a time effective to pasteurize the mixture, such as with continued mixing.

In another approach, the plant-based cheese products can be made by the method comprising melting a fat component, adding a plant-based protein, a flexibility enhancing agent, and water to the melted fat component to provide a first mixture. The fat component has a solid fat content in the range of about 30% to about 60% at 50° F. and 0% to about 10% at 92° F. Other optional ingredients may be added at this point or later in the process. The ingredients are blended at a shear rate sufficient to provide a homogeneous mixture. The ingredients are also heated at a temperature of about 160° F. to about 215° F., in another aspect about 165° F. to about 200° F., and in another aspect about 175° F. to about 190° F. At least a first starch and a second starch are combined with water and then added to the heated mixture, wherein the first starch is a hydrophobic starch, and the second starch is a modified starch, to provide a second mixture. The second mixture is then held at the heated temperature for at the increased temperature for a time effective to pasteurize the mixture, such as with continued mixing if desired.

In one particular approach, the method comprises melting a fat component having a solid fat content in the range of about 30% to about 60% at 50° F. and 0% to about 10% at 92° F.; adding water to the melted fat source to form a first mixture; adding a plant-based protein, a hydrophobic starch, and a modified starch to the first mixture and mixing to form a second mixture; heating the second mixture to a temperature within the range of about 170° F. to about 200° F.; holding the mixture at the heating temperature for at heating time period within the range of about 30 seconds to about 90 seconds to form a heated mixture; and cooling the heated mixture to form the plant-based cheese product.

In another approach, the plant-based cheese products can be made by the method comprising: melting a fat source having a solid fat content in the range of about 30% to about 60% at 50° F. and 0% to about 10% at 92° F.; adding a modified starch and a hydrophobic starch to the melted fat source to form a first mixture; adding water, a flexibility enhancing agent, and plant-based protein to the first mixture and mixing to form a second mixture; heating the second mixture to a temperature within the range of about 170° F. to about 200° F.; holding the mixture at the heating temperature for a heating time period within the range of about 30 seconds to about 90 seconds to form a heated mixture; and cooling the heated mixture to form the plant-based cheese product.

In one aspect, when mixing the plant-based protein, hydrophobic starch, and a modified starch with the melted fat, it may be desirable to mix the ingredients at a speed of at least about 500 rpm, in another aspect about 500 rpm to about 2500 rpm, and for a mixing time period within the range of about 2 minutes to about 15 minutes to provide a homogeneous, pasteurized mixture.

In another aspect, any of the methods described herein may further comprise filling the heated mixture into one or more containers prior to the cooling step. In another aspect, the cooling step may be accomplished on a chill belt.

In another aspect, any of the methods described herein may further comprise adding an acidulant to the first or second mixture. In one approach, the acidulant is added in an amount effective to provide a pH in the range of about 4.4 to about 5.7, in another aspect a pH of about 4.7 to about 5.5, in another aspect about 4.8 to about 5.3, and in another aspect about 4.8 to about 5.0, in the final plant-based cheese product. The acidulant may be any food grade acidulant, such as citric acid, lactic acid, or combination thereof. In one aspect, the acidulant is lactic acid, which can provide a characteristic dairy flavor to the plant-based cheese product. The inclusion of the acidulant to a provide a pH in the described ranges contributes to microbial stability of the product as well as providing desirable flavor.

In another aspect, any of the methods described herein may further comprise combining the plant-based protein with a flavor masking agent and water prior to combining the plant-based protein with other ingredients of the plant-based cheese product.

In another aspect, any of the methods described herein may further comprise adding one or more of salt, a preservative, colorant, and flavor. Particulates or inclusions (e.g., herbs, spices, pepper pieces) may also be added with any of the methods described herein.

The methods described herein may also further comprise cutting the plant-based cheese product into various shapes and sizes, such as blocks, slices, cubes, shreds, and the like.

Cheeses may be cooked and processed using any conventional equipment, including the use of a laydown cooker, kettle, or other device. Shredding and packaging may also be accomplished with conventional equipment.

To further illustrate the present disclosure, examples are given herein. It is to be understood that these examples are provided for illustrative purposes and are not to be construed as limiting the scope of the present disclosure.

### EXAMPLES

### Example 1

Seven examples of the plant-based cheese products disclosed herein were prepared. Each of the example plant-based cheese products included chickpea protein as the plant-based protein, and coconut oil as the oil.

Each of the example plant-based cheese products were prepared by first melting coconut oil in a cooker. Water was added to the melted coconut oil, and then lactic acid was added in an amount effective to provide a pH within the range of about 4.8 to about 5.0 in the final product. Chickpea protein, maltodextrin, salt, sorbic acid, colorant, flavors, REZISTA® starch (Tate & Lyle), and ACCUBIND® starch (Cargill) were added, and the ingredients were then mixed and heated (via steam injection) in a steam injection cooker (Stephan Machinery GmbH) at shear rate and for a time period sufficient to produce a homogenous mixture. Once the mixture was well mixed, it was further heated (via steam injection) to 185° F. and held at 185° F. for 1 minute. Then, the heated mixture was filled into a box and allowed to cool to form a block of the plant-based cheese product.

The general formulation of each plant-based cheese product is shown in Table 1, with the wt % of each ingredient that was used (based on the total weight of the plant-based cheese product). In Table 1, the plant-based cheese products are referred to as “PBCA 1,” “PBCA 2,” “PBCA 3,” “PBCA 4,” “PBCA 5,” “PBCA 6,” and “PBCA 7.”

TABLE 1

| | PBCA 1 | PBCA 2 | PBCA 3 | PBCA 4 | PBCA 5 | PBCA 6 | PBCA 7 |
|---|---|---|---|---|---|---|---|
| Ingredient | (wt %) | (wt %) | (wt %) | (wt %) | (wt %) | (wt %) | (wt % |
| Colorant | 0.07 | 0.07 | 0.07 | 0.07 | 0.07 | 0.06 | 0.06 |
| Salt | 1.70 | 1.70 | 1.70 | 1.70 | 1.70 | 1.70 | 1.70 |
| Sorbic Acid | 0.18 | 0.18 | 0.18 | 0.18 | 0.18 | 0.18 | 0.18 |
| REZISTA ® | 2.00 | 2.00 | 2.00 | 2.00 | 2.00 | 2.00 | 2.00 |
| Starch | | | | | | | |
| ACCUBIND ® | 9.00 | 9.00 | 9.00 | 9.00 | 9.00 | 9.00 | 9.00 |
| Starch | | | | | | | |
| Flavors | 2.53 | 2.55 | 1.43 | 1.43 | 1.48 | 2.53 | 2.55 |
| ARTESA ® | 13.33 | 13.33 | 13.33 | 13.33 | 13.33 | 6.67 | 6.67 |
| Chickpea | | | | | | | |
| Protein | | | | | | | |
| STAR-DRI ® | 2.57 | 2.55 | 3.74 | 3.74 | 3.69 | 9.51 | 9.49 |
| 10 | | | | | | | |
| Maltodextrin | | | | | | | |
| Coconut Oil | 24.09 | 24.09 | 24.10 | 24.10 | 24.10 | 24.24 | 24.24 |
| Water | 35.43 | 35.43 | 35.35 | 35.35 | 35.35 | 35.01 | 35.01 |
| Lactic Acid | 0.10 | 0.10 | 0.10 | 0.10 | 0.10 | 0.10 | 0.10 |
| (88%) | | | | | | | |
| Condensate | 9.00 | 9.00 | 9.00 | 9.00 | 9.00 | 9.00 | 9.00 |
| Total | 100.00 | 100.00 | 100.00 | 100.00 | 100.00 | 100.00 | 100.00 |
| Water % | 46.50% | 46.50% | 46.50% | 46.50% | 46.50% | 46.50% | 46.50% |
| Fat % | 24.40% | 24.40% | 24.40% | 24.40% | 24.40% | 24.40% | 24.40% |
| Crude | 8.00% | 8.00% | 8.00% | 8.00% | 8.00% | 4.00% | 4.00% |
| protein % | | | | | | | |
| Total salt % | 1.70% | 1.70% | 1.70% | 1.70% | 1.70% | 1.70% | 1.70% |

Each of the example plant-based cheese products had an appearance, taste, cold texture, and hot/melt texture consistent with consumer expectations for a dairy-based cheese product.

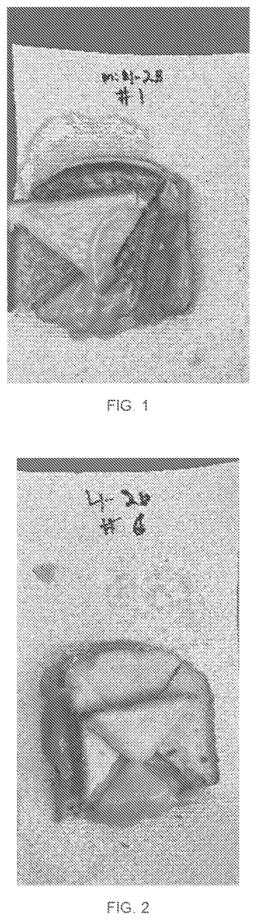

Further, for each of PBCA 1 and PBCA 6 a slice of the plant-based cheese product was placed between two slices of bread and grilled to produce a grilled cheese type product. The slice of each of PBCA 1 and PBCA 6 melted. The grilled cheese type product with PBCA 1 melted therein is shown in FIG. 1. The grilled cheese type product with PBCA 6 melted therein is shown in FIG. 2.

### Example 2

Six additional examples of the plant-based cheese products disclosed herein were prepared. Each of the additional examples of the plant-based cheese products had the same general formulation as PBCA 1 (shown in Table 1), except that the additional examples did not include colorant or flavors and included additional maltodextrin to replace the lack of colorant and flavors.

Each of the additional plant-based cheese products were prepared by first melting the coconut oil. Then, water was added to the melted coconut oil. Then, the lactic acid was added to produce a pH within the range of about 4.8 to about 5.0 in the final product. Then, the chickpea protein, maltodextrin, salt, sorbic acid, REZISTA® starch (Tate & Lyle), and ACCUBIND® starch (Cargill) were added. The ingredients were then mixed and heated (via steam injection) in a steam injection cooker (Stephan Machinery GmbH) at the mixing speed (shown in Table 2) for the mixing time period (shown in Table 2). Once the mixture was mixed, it was heated (via steam injection) to 185° F. and held at 185° F. for 1 minute. Then, the heated mixture was filled into a box and allowed to cool to form a block of the example plant-based cheese product.

The mixing speed and the mixing time period for each of the additional example plant-based cheese products are shown in Table 2. In Table 2, the additional example plant-based cheese products are referred to as “PBCA 8,” “PBCA 9,” “PBCA 10,” “PBCA 11,” “PBCA 12,” and “PBCA 13.”

TABLE 2

| Plant-Based Cheese | Mixing Speed | Mixing Time |
|---|---|---|
| Alternative | (rpm) | Period (minutes) |
| PBCA 8 | 1200 | 4 |
| PBCA 9 | 2500 | 4 |
| PBCA 10 | 1200 | 10 |
| PBCA 11 | 2500 | 10 |
| PBCA 12 | 500 | 4 |
| PBCA 13 | 500 | 10 |

Each of the additional example plant-based cheese products had an appearance, taste, cold texture, and hot/melt texture consistent with consumer expectations for a dairy-based cheese.

### Example 3

An additional example of the plant-based cheese product disclosed herein was prepared. The additional example of the plant-based cheese product had the same general formulation as PBCA 1 (shown in Table 1), except that the additional example did not include colorant and included additional maltodextrin to replace the lack of colorant.

The additional example plant-based cheese product was prepared by first melting the coconut oil. Then, the REZISTA® starch and ACCUBIND® starch were added, and the combination of the melted coconut oil, the REZISTA® starch, and the ACCUBIND® starch was thoroughly mixed to provide a homogeneous mixture of the starches in the melted coconut oil. Water and lactic acid were added. Lactic acid was added in an amount effective to provide a pH within the range of about 4.8 to about 5.0 in the final product. The chickpea protein, maltodextrin, salt, and sorbic acid were then added. The ingredients were mixed and heated (via steam injection) in a steam injection cooker (Stephan Machinery GmbH) at 2500 rpm for 10 minutes. Flavors were added, and the mixture was heated (via steam injection) to 185° F. and held at 185° F. for 1 minute. The heated mixture was filled into a box and allowed to cool to form an about 20 lb to about 24 lb block of the example plant-based cheese product.

The additional example plant-based cheese product had an appearance, taste, cold texture, and hot/melt texture consistent with consumer expectations for a dairy-based cheese.

### Example 4

A further example of the plant-based cheese product disclosed herein can be prepared. The additional example of the plant-based cheese product has the same general formulation as PBCA 1 (shown in Table 1), except that the additional example did not include colorant or flavors and included additional maltodextrin to replace the lack of colorant or flavors.

The additional example plant-based cheese product is prepared by first melting the coconut oil. Water and lactic acid are added. Lactic acid is added in an amount effective to provide a pH within the range of about 4.8 to about 5.0 in the final product. The chickpea protein, maltodextrin, salt, and sorbic acid are then added. The ingredients are mixed and heated (via steam injection) in a steam injection cooker (Stephan Machinery GmbH) at shear rate and for a time period sufficient to produce a homogenous mixture. The mixture is then heated (via steam injection) to 185° F. Then, the REZISTA® starch and ACCUBIND® starch are added to water and thoroughly mixed to provide a homogeneous mixture. The starches and water mixture are added to the mixture in a steam injection cooker, and then the mixture is held at 185° F. for 1 minute. The heated mixture is filled into a box and allowed to cool to form a block of the example plant-based cheese product having an appearance, taste, cold texture, and hot/melt texture consistent with consumer expectations for a dairy-based cheese.

It is to be understood that the ranges provided herein include the stated range and any value or sub-range within the stated range. For example, a range of about 5 wt % to about 15 wt % should be interpreted to include not only the explicitly recited limits of range of about 5 wt % to about 15 wt %, but also to include individual values, such as 6.35 wt %, 7.5 wt %, 10 wt %, 12.75 wt %, 14 wt %, etc., and sub-ranges, such as about 7 wt % to about 10.5 wt %, about 8.5 wt % to about 12.7 wt %, about 9.75 wt % to about 14 wt %, etc. Furthermore, when “about” is utilized to describe a value, this is meant to encompass minor variations (up to +/−10%) from the stated value.

All percentages and ratios are calculated by weight unless otherwise indicated. All percentages and ratios are calculated based on the total weight of the compound or composition unless otherwise indicated.

Reference throughout the specification to “an example,” “one example,” “another example,” “some examples,” “other examples,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

1. A plant-based cheese product comprising:
a plant-based protein;
at least a first starch and a second starch, the first starch comprising a hydrophobic starch and the second starch comprising a modified starch;
a flexibility enhancing agent;
a fat component having a solid fat content in the range of 30% to about 60% at 50° F. and 0% to about 10% at 92° F.; and
an acidulant in an amount effective to provide a pH of the plant-based cheese product of about 4.5 to about 5.7.

2. The plant-based cheese product as defined in claim 1, wherein the plant-based protein is present in an amount within the range of about 1 wt % to about 25 wt % crude protein, based on a total weight of the plant-based cheese product.

3. The plant-based cheese product as defined in claim 1, wherein the plant-based protein is present in an amount within the range of about 2 wt % to about 20 wt % crude protein, based on a total weight of the plant-based cheese product.

4-5. (canceled)

6. The plant-based cheese product as defined in claim 1, wherein the first starch is present in an amount within the range of about 0.5 wt % to about 15 wt %, based on a total weight of the plant-based cheese product.

7. The plant-based cheese product as defined in claim 1, wherein the second starch is present in an amount within the range of about 0.5 wt % to about 10 wt %, based on a total weight of the plant-based cheese product.

8. The plant-based cheese product as defined in claim 1, wherein the fat component is present in an amount within the range of about 15 wt % to about 30 wt %, based on a total weight of the plant-based cheese product.

9. (canceled)

10. The plant-based cheese product as defined in claim 1, wherein the plant-based cheese product has a total solids content within the range of about 45 wt % to about 65 wt %.

11-13. (canceled)

14. The plant-based cheese product as defined in claim 1, wherein the plant-based protein comprises one or more of chickpea protein, fava protein, soy protein, mung bean protein, pea protein, canola protein, and lentil protein.

15. (canceled)

16. The plant-based cheese product as defined in claim 1, wherein the fat component comprises one or more of coconut oil, palm oil, palm oil fraction, shea butter, and shea olein.

17. The plant-based cheese product as defined in claim 16, wherein the fat component further comprises one or more of soybean oil, sunflower oil, olive oil, canola oil, peanut oil, sesame oil, and corn oil.

18-35. (canceled)

36. The plant-based cheese product as defined in claim 1, wherein the flexibility enhancing agent comprises one or more of instant starch, xanthan gum, guar gum, locust bean gum, cellulose gum, fenugreek gum, konjac gum, agar, gellan gum, propylene glycol alginate, alginate, microcrystalline cellulose, carboxymethyl cellulose, konjac glucomannan, carrageenan, and pectin.

37. The plant-based cheese product as defined in claim 1, wherein the flexibility enhancing agent is present in an amount within the range of about 0.1 wt % to about 20 wt %, based on a total weight of the plant-based cheese product.

38-39. (canceled)

40. A plant-based cheese product comprising:
a protein of non-animal origin;
at least a first starch and a second starch, the first starch comprising a hydrophobic starch and the second starch comprising a modified starch;
a fat component having a solid fat content in the range of 30% to about 60% at 50° F. and 0% to about 10% at 92° F.; and
an acidulant in an amount effective to provide a pH of the product of about 4.5 to about 5.7.

41. The plant-based cheese product as defined in claim 40, wherein the protein is present in an amount within the range of about 1 wt % to about 25 wt % crude protein, based on a total weight of the product.

42. The plant-based cheese product as defined in claim 40 or 41, wherein the first starch is present in an amount within the range of about 0.5 wt % to about 15 wt %, based on a total weight of the product.

43. The plant-based cheese product as defined in claim 40, wherein the second starch is present in an amount within the range of about 0.5 wt % to about 10 wt %, based on a total weight of the product.

44. The plant-based cheese product as defined in claim 40, wherein the fat component is present in an amount within the range of about 15 wt % to about 30 wt %, based on a total weight of the product.

45. The plant-based cheese product as defined in claim 40, wherein the product has a total solids content within the range of about 45 wt % to about 65 wt %.

46. The plant-based cheese product as defined in claim 40, wherein the protein comprises one or more of a fermented protein, a fungus protein, chickpea protein, fava protein, soy protein, mung bean protein, pea protein, canola protein, and lentil protein.

47-52. (canceled)

53. The plant-based cheese product as defined in claim 40, wherein the first starch comprises an octenyl succinic anhydride starch.

54. The plant-based cheese product as defined in claim 40, wherein the second starch comprises one or more of a modified waxy starch and a hydrolyzed amylose-containing starch.

55. The plant-based cheese product as defined in claim 1, wherein the first starch comprises an octenyl succinic anhydride starch.

56. The plant-based cheese product as defined in claim 1, wherein the second starch comprises one or more of a modified waxy starch and a hydrolyzed amylose-containing starch.

57-60. (canceled)
